(19) United States
(12) Patent Application Publication
(10) Pub. No.: US 2007/0074475 A1
(43) Pub. Date: Apr. 5, 2007

(54) Storm door insert

(76) Inventor: Robert John Kopach, Elmhurst, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/368,346

(22) Filed: Mar. 3, 2006

Related U.S. Application Data
(60) Provisional application No. 60/658,233, filed on Mar. 3, 2005.

(51) Int. Cl. B44F 7/00

(52) U.S. Cl. 52/314

(57) ABSTRACT

An insert for storm doors is provided. The insert includes swing-out doors that allow a homeowner to pop out and pass items through the storm door without requiring that the storm door be opened.

This application claims priority pursuant to 35 U.S.C. 119(e) to co-pending U.S. Provisional Patent Application Ser. No. 60/658,233, filed Mar. 3, 2005, the entire disclosure of which is incorporated herein by reference.

### FIELD OF THE INVENTION

The present invention is broadly concerned with storm doors for homes and other structures. More particularly, the invention is concerned with an insert to install in place of the removable glass or screen of a storm door.

### BACKGROUND OF THE INVENTION

Many homes today include storm doors on their exteriors. Often the storm door will have a large open framework that supports either a screen or a glass insert. In such storm doors the large screen or glass insert is usually removable. This allows the homeowner to easily switch the screen for the glass and vice versa. In addition to providing an aesthetically pleasing appearance to the home, these storm doors allow the homeowner to use the door in a manner similar to a widow, letting in light with the glass and letting in fresh air as well as light with the screen. Notwithstanding, these storm doors are often fairly heavy. At times such as Halloween, when numerous trick-or-treaters visit the home to receive candy and other treats from the homeowner, the heavy storm door can become an annoying obstacle to the homeowner. Therefore, it would be beneficial to provide an insert for a storm door that allows the home owner to pass items, such as candy and other treats, from inside the home to visitors outside the home without the need to continuously open and close the storm door.

### SUMMARY OF THE INVENTION

An object of the instant invention is to provide a way for a home owner to pass items, such as candy and other treats, from inside the home to visitors outside the home without the need to continuously open and close a storm door located on the house. Another object of the instant invention is to provide an apparatus to pass objects through a storm door that is easy to install and aesthetically pleasing.

The above described objects are achieved through the use of an insert for a storm door that includes swing-out doors. In a preferred embodiment the insert is made of reinforced corrugated cardboard, and the swing-out doors are die-cut out of the cardboard to allow the homeowner to pop out and distribute candy and treats without continuously opening and closing the heavy storm door. The cardboard is light weight and can include a fold line for easy storage of the insert when not in use.

The insert of the instant invention is simple to install. The homeowner merely removes the existing screen or glass insert from the storm door and replaces it with the inventive insert.

In a preferred embodiment of the instant invention, the insert is sized to fit large storm doors (i.e. 74½″ H×30¼″ W for 36″ doors), but is capable of use in smaller storm doors by trimming down the edges of the insert with a utility knife. To aid in trimming, the insert may include marked or pre-scored lines at dimensions that fit various standard storm door sizes. Nevertheless, it will be appreciated that larger or smaller sized inserts may also be designed to custom fit any size of door or opening now known or hereafter developed without departing from the spirit and scope of the instant invention. In an alternative embodiment, a smaller insert is provided that is approximately half the size of the preferred embodiment described above to fit into the sliding window location of storm doors so equipped.

In another preferred embodiment, the insert is pre-printed on one side with festive decorations, such as the words “Halloween” and “Trick or Treat”, and other Halloween artwork, making the insert aesthetically pleasing during the Halloween season.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a front elevation view of an insert of the instant invention.

FIG. 2 is a rear exploded view of a storm door utilizing the insert of the instant invention.

FIG. 3 is a rear view of an embodiment of the insert of the instant invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

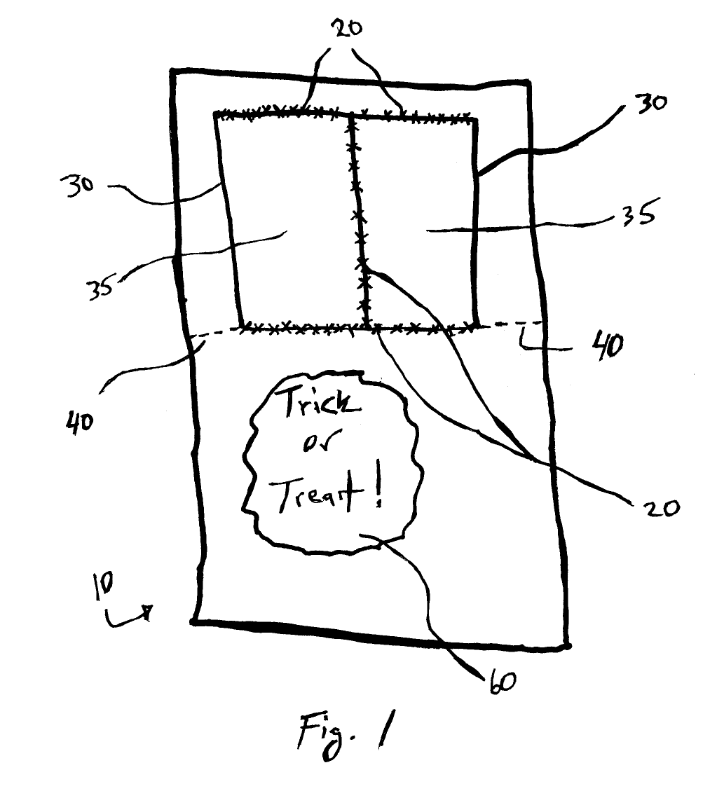

Referring to FIG. 1, the front surface of a preferred embodiment of insert 10 of the instant invention is shown. The body of insert 10 is made of reinforced corrugated cardboard, or other suitable material, and includes swing-out doors 35 that allow the homeowner to pop out and distribute candy and treats. Swing-out doors 35 are made in the cardboard by making die-cuts along lines 20 and allowing doors 35 to fold (or hinge) and swing in and out along lines 30. Insert 10 is pre-folded along line 40 to provide easy storage of insert 10 when not in use. The front side of insert 10 includes pre-printed decorations 60 for an aesthetically pleasing appearance.

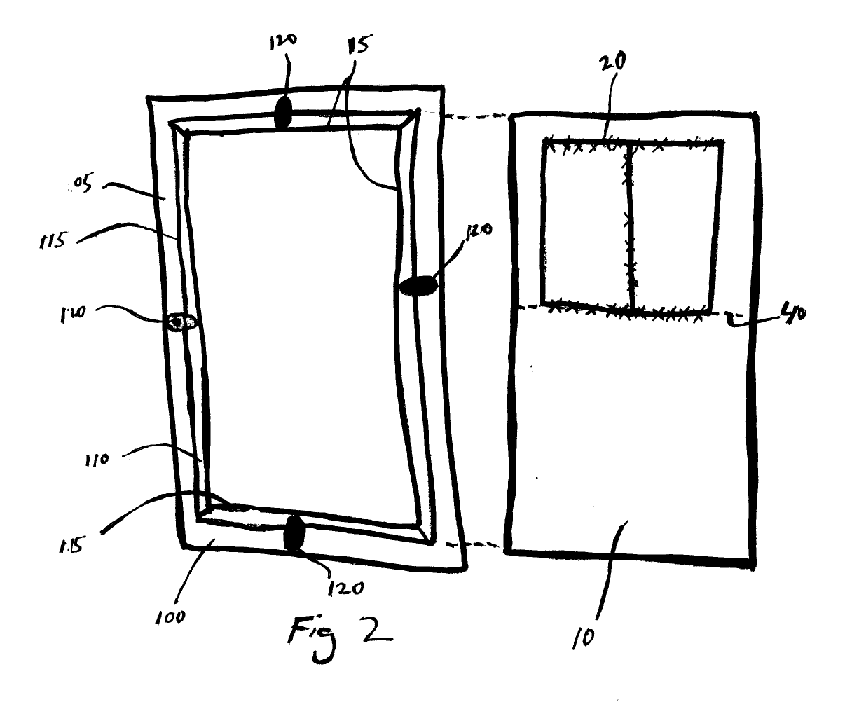

Referring to FIG. 2, the installation by a homeowner of insert 10 into frame 100 of a typical storm door is shown and described. The homeowner removes the existing screen or glass insert from frame 100 of the storm door and replaces it with insert 10. Typically, the back side of frame 100 will include inner retention lip 110 and rotating support members 120. The support members, 120, are usually connected to the outer portion, 105, of frame 100 by screw fasteners (not shown). The screw fasteners are loosened to allow support members to rotate away from inner lip 110 to permit removal and insertion of the glass or screen insert. Insert 10 of the instant invention is inserted and removed in the same manner. Insert 10 is sized to fit over retention lip 110 and within the inner perimeter (115) of outer portion 105. Insert 10 is held in position by rotating support members 120 over insert 10 and tightening down the screw fasteners such that insert 10 is held in position between support members 120 and inner lip 105.

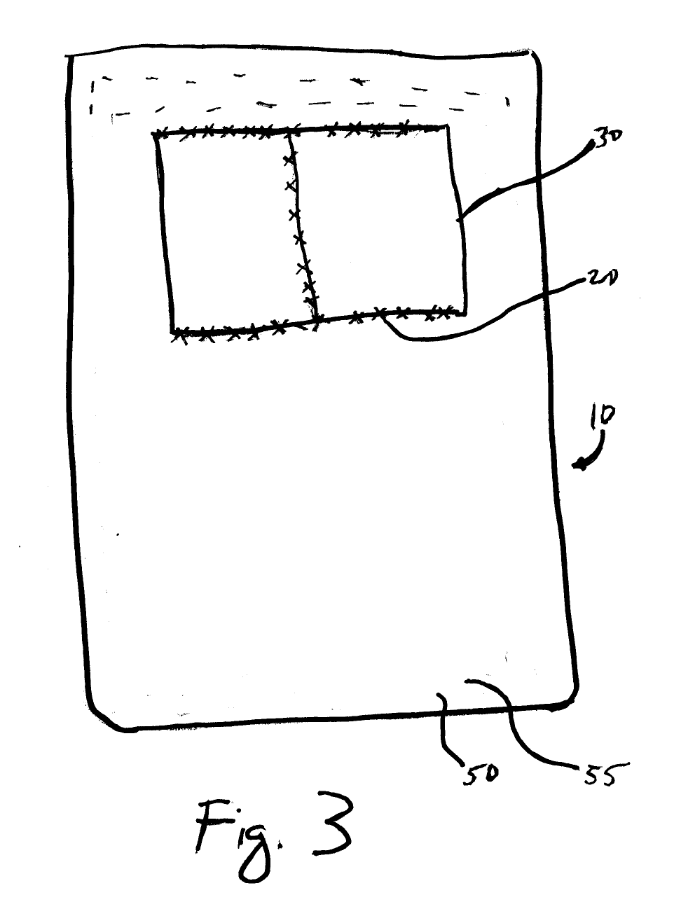

In one embodiment of the instant invention, insert 10 is sized to fit large storm doors (i.e. is of equal size of the glass or screen inserts for such doors), but is capable of use in smaller storm doors by trimming down the edges of the insert with a utility knife. Referring to FIG. 3, the rear side (inside or home side of door) of a preferred embodiment of insert 10 is shown that includes features to aid in trimming by the homeowner. Insert 10 includes line markings 50 and 55 printed at dimensions that fit various standard storm door sizes. Lines 50 and 55 provide a guide for the homeowner when trimming. Alternatively, line markings 50 and 55 may be scored into insert 10 to aid further in trimming.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. An insert for a storm door comprising:
a body; and
swing-out doors within said body.

2. The insert as claimed in claim 1 wherein said body is made of cardboard.

3. The insert as claimed in claim 1 wherein said doors are die-cut out of said body.

4. The insert as claimed in claim 3 wherein said doors swing in and out along a fold line.

5. The insert as claimed in claim 1 further comprising a fold line across said body.

6. The insert as claimed in claim 1 wherein the insert is pre-sized to fit within a frame of the storm door.

7. The insert as claimed in claim 1 further including a trim line on said body.

8. The insert as claimed in claim 7 wherein said trim line is printed on said body.

9. The insert as claimed in claim 7 wherein said trim line is pre-scored into said body.
